(19) United States
(12) Patent Application Publication
(10) Pub. No.: US 2026/0251151 A1
(43) Pub. Date: Aug. 27, 2026

(54) HIGH-SPEED PRESSURIZED IMPELLER DISK

(71) Applicant: P3 Technologies, LLC, Jupiter, FL (US)

(72) Inventors: Brandon A. Demski, Jupiter, FL (US); Robert W. Sanders, Stuart, FL (US)

(21) Appl. No.: 19/655,049

(22) Filed: Apr. 22, 2026

Related U.S. Application Data
(63) Continuation-in-part of application No. 19/547,809, filed on Feb. 24, 2026.
Application No. 19/547,809 is a continuation of application No. 18/772,749, filed on Jul. 15, 2024, now Pat. No. 12,584,491.
Application No. 18/772,749 is a continuation of application No. 16/866,623, filed on May 5, 2020, now Pat. No. 12,060,889.

(51) Int. Cl. F04D 29/22; F01D 5/14

(52) U.S. Cl. CPC F04D 29/2222; F01D 5/147; F05B 2240/301; F05D 2240/301; F05D 2260/941

(57) ABSTRACT

A pressurized impeller, including a hub, a tip, a forward cavity wall including a first forward surface and a first aft surface, an aft cavity wall including a second forward surface and a second aft surface, an axial opening, a radial opening arranged proximate the tip, one or more blades arranged on the first forward surface, a plurality of fluid flow paths formed between the axial opening, the radial opening, and the one or more blades, an internal pressurized cavity formed between the forward cavity wall and the aft cavity wall, and a support structure arranged in the internal pressurized cavity.

### CROSS-REFERENCE TO RELATED APPLICATIONS

This application is filed under 35 U.S.C. § 120 as a continuation-in-part of U.S. Patent Application No. 19/547,809, filed on February 24, 2026, which application is a continuation of U.S. Patent Application No. 18/772,749, filed on July 15, 2024, now U.S. Patent No. 12,584,491, which application is a continuation of U.S. Patent Application No. 16/866,623, filed on May 5, 2020, now U.S. Patent No. 12,060,889, which applications are hereby incorporated by reference in their entireties.

### FIELD

The present disclosure relates generally to pumps, compressors, and turbines, and more specifically centrifugal pump impellers and radial turbines.

### BACKGROUND

To achieve significant pressure-rise in a pump traditionally requires multiple impellers; also known as stages. This is both cost prohibitive and weight penalizing as the system part count increases with each subsequent impeller. Utilizing a single impeller to achieve the pressures that multiple impellers produce requires extremely high rotor speeds, which result in highly stressed impeller disks and blades, which ultimately limit the maximum pressure and life of the impeller. This stress is principally a function of the impeller’s angular momentum which forces the mass outwards radially, creating high stress concentrations at regions where minimal movement occurs relative to the forces exerted and the adjoining geometry.

Traditional designs of high pressure-rise impellers rely on reducing the mass of the impeller disk, in turn lowering the stresses of the impeller along the disk, blades, hub, and shroud. While this weight reduction works to an extent, a point of diminishing returns is achieved where the impeller cannot support the torque and pressure exerted upon itself by the fluid it is pumping. This condition is defined as the tip speed limit of an impeller and is historically a combination of impeller material density and fluid dependent due to temperature, density, and viscosity of the acting medium on the impeller hydro surfaces.

### SUMMARY

The present disclosure is directed to one or more exemplary embodiments of a pressurized impeller.

In an exemplary embodiment, the pressurized impeller may comprise a hub, a tip, a forward cavity wall including a first forward surface and a first aft surface, an aft cavity wall including a second forward surface and a second aft surface, an axial opening, a radial opening arranged proximate the tip, one or more blades arranged on the first forward surface, a plurality of fluid flow paths formed between the axial opening, the radial opening, and the one or more blades, an internal pressurized cavity formed between the forward cavity wall and the aft cavity wall, and a support structure arranged in the internal pressurized cavity.

In an exemplary embodiment, the support structure may comprise a stiffening rib arranged on the first aft surface. In an exemplary embodiment, the stiffening rib may be at least partially aligned with a blade of the one or more blades along the forward cavity wall. In an exemplary embodiment, the stiffening rib may comprise a forward edge fixedly secured to the first aft facing surface, and the forward edge may always be aligned with a blade of the one or more blades along the forward cavity wall.

In an exemplary embodiment, the stiffening rib may be a curvilinear plate extending from the hub at least partially to the tip. In an exemplary embodiment, an axial length of the stiffening rib may decrease in a radially outward direction. In an exemplary embodiment, the stiffening rib may comprise a proximal edge connected to the hub, the pressurized impeller may further comprise an axis of rotation, and the proximal edge may be arranged at an acute angle with respect to the axis of rotation. In an exemplary embodiment, the support structure may comprise at least one stiffening rib arranged on at least one of the first aft surface and the second forward surface.

In an exemplary embodiment, the at least one stiffening rib may extend in a radially outward direction relative to the hub, or a circumferential direction around the hub. In an exemplary embodiment, the support structure may comprise one or more annular rings extending circumferentially around the hub. In an exemplary embodiment, each ring of the one or more annular rings may be arranged radially between and spaced apart from the tip and the hub, and may extend from the aft wall to the forward wall. In an exemplary embodiment, at least one ring of the annular ring may be arranged nonparallel to the axis of rotation.

In an exemplary embodiment, the pressurized impeller may further comprise at least one stiffening rib arranged on at least one of the first aft surface and the second forward surface. In an exemplary embodiment, the at least one stiffening rib may extend in a radially outward direction relative to the hub. In an exemplary embodiment, the at least one stiffening rib may extend in a circumferential direction around the hub. In an exemplary embodiment, the support structure may comprise a beam arranged on the first aft surface proximate a leading edge of a blade of the pressurized impeller.

The present disclosure is directed to one or more exemplary embodiments of a pressurized impeller.

In an exemplary embodiment, the pressurized impeller may comprise a hub, a tip, a forward cavity wall including a first forward surface and a first aft surface, an aft cavity wall including a second forward surface and a second aft surface, an axial opening, a radial opening arranged proximate the tip, one or more blades arranged on the forward cavity wall, a plurality of fluid flow paths formed between the axial opening, the radial opening, and the one or more blades, an internal pressurized cavity formed between the forward cavity wall and the aft cavity wall, and one or more stiffening ribs arranged on the forward cavity wall, wherein at least one blade of the one or more blades and at least one stiffening rib of the one or more stiffening ribs are aligned along the forward cavity wall in a path extending from the hub at least partially to the tip.

In an exemplary embodiment, the path may be curvilinear. In an exemplary embodiment, the one or more blades may be arranged on the first forward surface, and the one or more stiffening ribs may be arranged on the first aft surface. In an exemplary embodiment, at least one stiffening rib of the one or more stiffening ribs may be a curvilinear plate decreasing in axial length in a radially outward direction with respect to the hub.

The present disclosure is directed to one or more exemplary embodiments of a pressurized impeller.

In an exemplary embodiment, the pressurized impeller may comprise an axis of rotation, a hub, a forward wall including a first forward surface and a first aft surface, an aft wall including a second forward surface and a second aft surface, an axial opening, a radial opening, wherein the axial opening and the radial opening are connected within the pressurized impeller to form a plurality of fluid flow paths, and an internal pressurized cavity formed between the forward wall and the aft wall, wherein a first orifice opens into a tip of the pressurized impeller.

In an exemplary embodiment, a second orifice opens into at least one of the hub, the forward wall, and the aft wall. In an exemplary embodiment, the pressurized impeller further comprises one or more annular rings arranged in the internal pressurized cavity. In an exemplary embodiment, each ring of the one or more annular rings is arranged radially between and spaced apart from the tip and the hub, and extends from the aft wall to the forward wall. In an exemplary embodiment, at least one ring of the annular ring is arranged nonparallel to the axis of rotation.

In an exemplary embodiment, the pressurized impeller further comprises at least one stiffening rib arranged on at least one of the first aft surface and the second forward surface. In an exemplary embodiment, the at least one stiffening rib extends in a radially outward direction relative to the hub. In an exemplary embodiment, the at least one stiffening rib extends in a circumferential direction around the hub.

The present disclosure is directed to one or more exemplary embodiments of a pressurized impeller.

In an exemplary embodiment, the pressurized impeller may comprise a hub, a forward wall including a first forward surface and a first aft surface, an aft wall including a second forward surface and a second aft surface, an axial opening, a radial opening, wherein the axial opening and the radial opening are connected within the pressurized impeller to form a plurality of fluid flow paths, and an internal pressurized cavity formed between the forward wall and the aft wall, wherein a first orifice opens into the hub.

In an exemplary embodiment, a second orifice opens into at least one of the tip, the forward wall, and the aft wall. In an exemplary embodiment, the pressurized impeller further comprises one or more annular rings arranged in the internal pressurized cavity. In an exemplary embodiment, each ring of the one or more annular rings is arranged radially between and spaced apart from the tip and the hub, and extends from the aft wall to the forward wall. In an exemplary embodiment, at least one ring of the annular ring is arranged nonparallel to the axis of rotation.

In an exemplary embodiment, the pressurized impeller further comprises at least one stiffening rib arranged on at least one of the first aft surface and the second forward surface. In an exemplary embodiment, the at least one stiffening rib extends in a radially outward direction relative to the hub. In an exemplary embodiment, the at least one stiffening rib extends in a circumferential direction around the hub.

The present disclosure is directed to one or more exemplary embodiments of a pressurized impeller.

In an exemplary embodiment, the pressurized impeller may comprise a hub, a forward wall including a first forward surface and a first aft surface, an aft wall including a second forward surface and a second aft surface, an axial opening, a radial opening, wherein the axial opening and the radial opening are connected within the pressurized impeller to form a plurality of fluid flow paths, an internal pressurized cavity formed between the forward wall and the aft wall, and a support structure arranged in the internal pressurized cavity.

In an exemplary embodiment, the support structure comprises at least one stiffening rib arranged on at least one of the first aft surface and the second forward surface. In an exemplary embodiment, the at least one stiffening rib extends in a radially outward direction relative to the hub, or a circumferential direction around the hub. In an exemplary embodiment, the support structure comprises a beam arranged on the first aft surface proximate a leading edge of a blade of the pressurized impeller.

A centrifugal impeller that employs an internal pressurized cavity can reduce the stresses in the impeller disk, blades, shroud, and hub as the stiffness of the rotor is not compromised while weight is reduced across the component and peak stress regions are shifted across the part. This is due to the pressure acting in the same way a balloon does to support itself via pressure acting against the deflections naturally experienced under high rotor speed. The impeller can be a centrifugal pump or a radial inflow turbine. The pressurized cavity can be pressurized by a number of orifices that open into a pressurized section of the impeller, either through the hub, the aft wall, the forward wall, or the tip in order to adjust the pressure in the cavity from relatively low to relatively high. In an exemplary embodiment, the pressurized cavity can be pressurized by a number of orifices that open into a pressurized section of the impeller, for example thru the hub, the aft wall, the forward wall, and/or the tip in order to adjust the pressure in the cavity from relatively low to relatively high. The impeller can include annular rings extending between the aft wall and the forward wall through the pressurized cavity to stiffen the impeller. A plurality of beams or baffles can also be used to stiffen the impeller. Radial and tangential stiffening ribs on the aft and forward walls can also be used to stiffen the impeller.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1 is an isometric view of an embodiment of a high-speed pressurized impeller disk with the pressurized cavity of the present disclosure, and internal annular rings used to stiffen the cavity.

FIG. 2 shows a cross-sectional view of an embodiment of the high-speed pressurized impeller disk of the present disclosure without any internal support features within the cavity.

FIG. 3 is a cross-sectional view of an embodiment of the high-speed pressurized impeller disk that details the various ways in which the pressurized impeller disk of the present disclosure can be supplied or vented to the exterior of the impeller cavity through orifices.

FIG. 4 is a cross-sectional view of an embodiment of the pressurized impeller cavity of the present disclosure that contains internal annular support structures for stiffening of the disk and the aft wall.

FIG. 5 is an isometric view of an embodiment of the high-speed pressurized impeller disk of the present disclosure that utilizes an internal truss structure within the pressurized cavity to stiffen the disk and the aft wall.

FIG. 6 is an isometric view of an embodiment of the high-speed pressurized impeller disk of the present disclosure that details the use of ribs and spars for the stiffening of the disk in the pressurized impeller of the present disclosure.

FIG. 7A is a top perspective view of an embodiment of a high-speed pressurized impeller disk.

FIG. 7B is a bottom perspective view of the high-speed pressurized impeller disk.

FIG. 8 is a cross-sectional view of the high-speed pressurized impeller disk taken generally along line 8-8 in FIG. 7B.

FIG. 9 is a cross-sectional view of the high-speed pressurized impeller disk taken generally along line 9-9 in FIG. 7B.

### DETAILED DESCRIPTION

This application is intended to describe one or more embodiments of the present disclosure. It is to be understood that the use of absolute terms, such as “must,” “will,” and the like, as well as specific quantities, is to be construed as being applicable to one or more of such embodiments, but not necessarily to all such embodiments. As such, embodiments of the present disclosure may omit, or include a modification of, one or more features or functionalities described in the context of such absolute terms. In addition, the headings in this application are for reference purposes only and shall not in any way affect the meaning or interpretation of the present disclosure.

At the outset, it should be appreciated that like drawing numbers on different drawing views identify identical, or functionally similar, structural elements. It is to be understood that the claims are not limited to the disclosed aspects. It should be further understood that elements shown and/or described in the present disclosure are to be construed as being applicable to one or more of the embodiments disclosed herein, but not necessarily to all of the embodiments disclosed herein.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element, and a third element; or a device comprising a second element and a third element. A similar interpretation is intended when the phrase “used in at least one of:” is used herein.

The amount of pressure that an impeller can generate is limited by one principal feature, the tip speed of the impeller. As the tip speed is increased, the discharge pressure increases with the square of this velocity change. Consequently, the stresses in the impeller increase by the square of this tip speed change as well. Failure for conventional designs is limited by the life margin, wherein the stresses in the part will cause the impeller to fatigue and fracture given enough operating time. In high performance expendable systems, such as rocket engines, the life is not the issue but the maximum speed at which they can operate. In either of these cases, long life or high performance, decreasing the stress in the impeller allows for higher tip speeds, and in turn higher pressures. With the utilization of the pressurized impeller disk the same life and structural margins can be achieved in comparison to the historical designs while developing greater pressures.

The pressurized impeller disk of the present disclosure is a way to both stiffen and lighten the impeller disk. Stress in the impeller increases with speed via three main factors: 1) the increasing pressure of the fluid, 2) the torque generated on the impeller via the fluid pumping, and 3) the increasing angular momentum of the impeller. Since the pressure is a desirable outcome and the torque a byproduct of this, the only way to combat the stresses is via angular momentum. Angular momentum has two main components: velocity and weight. Since velocity is a fixed value, only weight can be addressed. By reducing the weight, the stresses can be reduced proportionally.

Historically, this is achieved by thinning the impeller disk to reduce stresses until such a point that the pressure loading and deflections overcome the stiffness imparted by the disk, resulting in an increasing stress with further thinning of the material. This is conceptually shown as a parabolic stress/weight curve with an ideal design point at the inflection for minimum stress. This approach results in an optimal design but produces high stress concentrations at principle locations in the impeller due to the planar nature of the disk. By employing an internal pressurized cavity, the weight can be shifted and reduced strategically. This allows for strain energy to be directed more controllably to create a more uniform stress profile across the entire impeller, resulting in a significantly reduced parabolic stress/weight curve and inflection point. This allows for lower stress, longer life, and higher performance impellers. This technology is not limited to just impellers for pumps either, radial inflow turbines, essentially a centrifugal pump in reverse, also benefit equivalently from this approach. Thus, for purposes of the description of the present disclosure, an impeller can be a centrifugal pump or a radial inflow turbine.

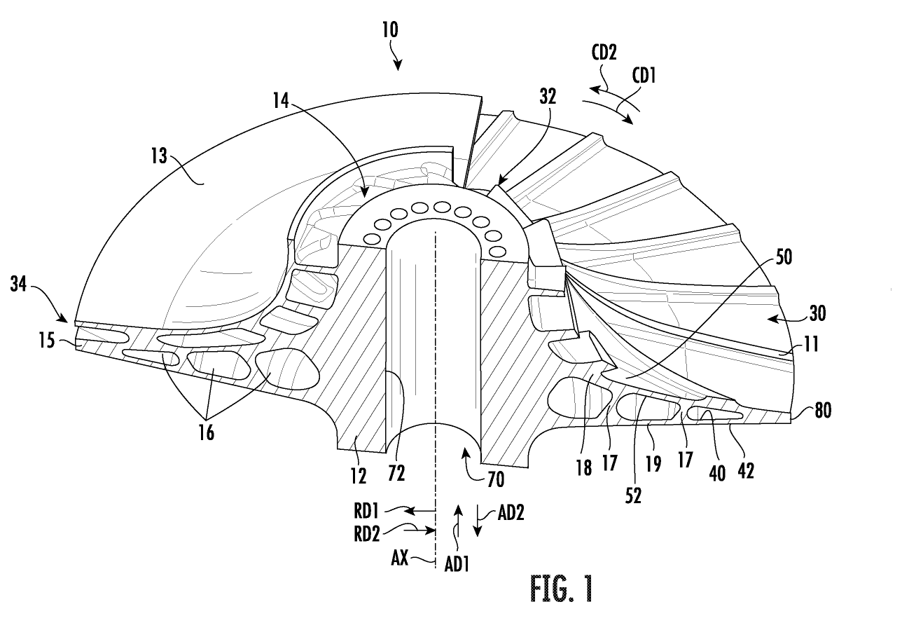

Referring now to the figures, an embodiment of pressurized impeller disk 10 is shown in FIG. 1. This is the generalized configuration of an impeller employing the technology. Pressurized impeller disk 10 comprises blades 11, which create the pressure rise, and hub 12, which attaches pressurized impeller disk 10 to the shaft. In an exemplary embodiment, pressured impeller disk 10 further comprises shroud 13, which increases impeller efficiency, and/or eye 14, which acts as the impeller inlet. In an exemplary embodiment, pressurized impeller disk 10 further comprises the tip 15 where the flow exits pressurized impeller disk 10. In a radial turbine, all of these features are the same except tip 15 becomes the inlet and eye 14 acts as the outlet. When referencing impeller orientation, there is the forward side of the impeller, the side in which eye 14 and shroud 13 reside, generally facing in axial direction AD1, and the aft side, opposite of eye 14 and shroud 13, generally facing in axial direction AD2. Pressurized impeller cavity 16 is arranged aft of blades 11, and acts as the main stress reducing and manipulating feature of the present disclosure. In an exemplary embodiment, pressurized impeller disk 10 further comprises annular ring internal support structure 17. Support structure 17 is positioned between forward cavity wall 18 and aft cavity wall 19.

Forward cavity wall 18 comprises forward facing surface 50 directed generally in axial direction AD1 and aft facing surface 52 directed generally in axial direction AD2. Blades 11 are connected to surface 50 and spaced apart circumferentially thereon, namely, in circumferential direction CD1, CD2. From eye 14, blades 11 extend in axial direction AD2, radial direction RD1, and circumferential direction CD1. Vanes 30 are formed circumferentially between blades 11 and include vane suction or inlet end 32 and vane discharge end 34. It should be appreciated that when pressurized impeller disk 10 is utilized as a radial inflow turbine the fluid flow in vanes 30 is reversed such that vanes 30 comprise vane suction or inlet end 34 and vane discharge end 32. Aft cavity wall 19 comprises forward facing surface 40 directed generally in axial direction AD1 and aft facing surface 52 directed generally in axial direction AD2.

In an exemplary embodiment, high-speed pressurized impeller disk 10 further comprises shroud 13 generally arranged proximate to forward cavity wall 18. For example, shroud 13 may be arranged on a top surface of blades 11 such that vanes 30 are formed by adjacent blades 11, shroud 13, and forward cavity wall 18. From eye 14, vanes 30 extend in axial direction AD2, radial direction RD1, and circumferential direction CD1 and form fluid flow paths.

Pressurized impeller cavity 16 is formed between forward facing surface 40, aft facing surface 52, radially outward facing surface 62, and radially inward facing surface 60. Radially outward facing surface 62 extends from forward facing surface 40 to aft facing surface 52 generally in direction AD1. Radially outward facing surface 62 is arranged proximate hub 12. In an exemplary embodiment, radially outward facing surface 62 is a curvilinear surface. Radially inward facing surface 60 extends from forward facing surface 40 to aft facing surface 52 generally in direction AD1. Radially inward facing surface 60 is arranged proximate to tip 15. In an exemplary embodiment, radially inward facing surface 60 is a curvilinear surface. In an exemplary embodiment, the length of radially inward facing surface 60 is less than the length of radially outward facing surface 62.

In an exemplary embodiment, hub 12 may comprise hole or through-hole 70 forming radially inward facing surface 72. High-speed pressurized impeller disk 10 is operatively arranged to rotate about axis AX.

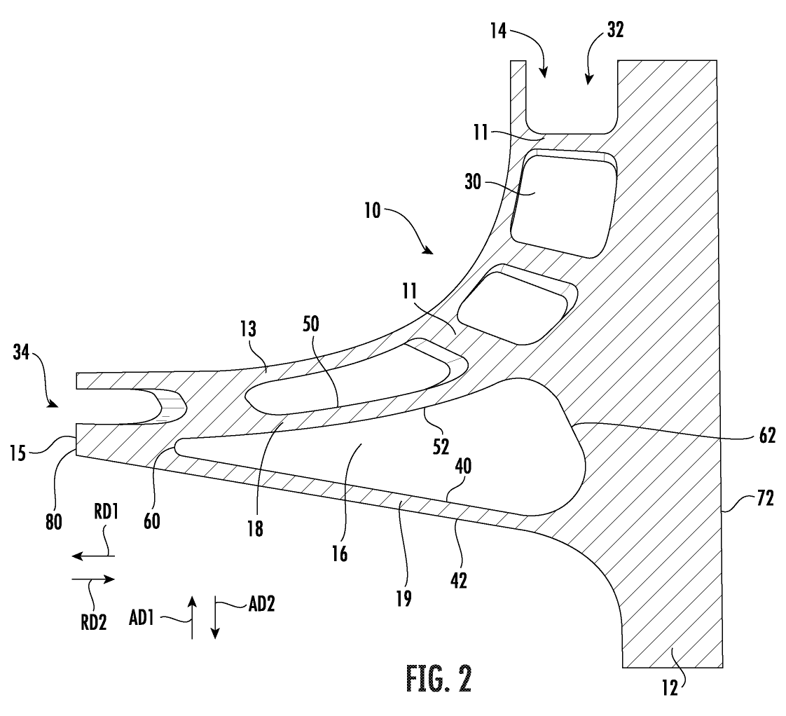

FIG. 2 is a cross-sectional view of high-speed pressurized impeller disk 10 shown in FIG. 1, without any support structure inside pressurized cavity 16. In an exemplary embodiment, cavity 16 is fully sealed. Utilizing a fully sealed cavity allows for the pocket formed by pressurized cavity 16 to be isobaric, constantly providing the stiffening independent of external forces. The pressure residing in pressurized cavity 16 can be tuned during manufacturing for structural or rotodynamic applications. Put another way, chamber 16 can be pre-pressurized during manufacturing with a pressure greater than ambient air pressure.

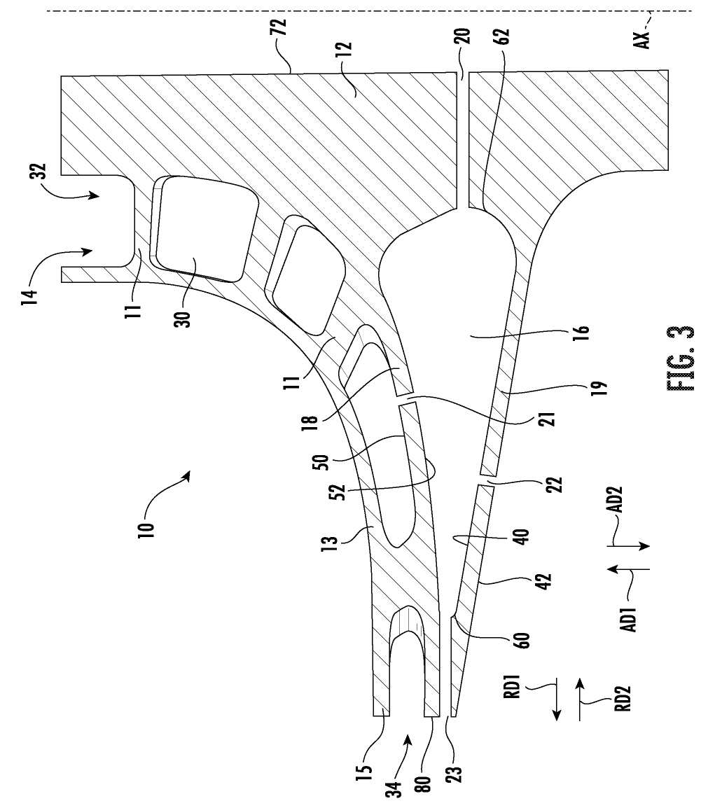

FIG. 3 is a cross-sectional view of high-speed pressurized impeller disk 10 shown in FIG. 2, further including orifices that allow pressurized cavity 16 to either be supplied or vented to external sources. In an exemplary embodiment, high-speed pressurized impeller disk 10 comprises hub orifice 20 extending from pressurized cavity 16 through hub 12. Hub orifice 20 extends generally in radially inward direction RD2 from radially outward facing surface 62 to radially inward facing surface 72. In an exemplary embodiment, hub orifice 20 is arranged perpendicular to axis of rotation AX.

In an exemplary embodiment, high-speed pressurized impeller disk 10 comprises forward wall orifice 21 extending from pressurized cavity 16 through forward cavity wall 18. Forward wall orifice 21 extends from aft facing surface 52 to forward facing surface 50. In an exemplary embodiment, forward wall orifice 21 fluidly connects pressurized cavity 16 with vane 30. In an exemplary embodiment, forward wall orifice 21 extends radially outward (i.e., in radial direction RD1) in axial direction AD1 (shown as angled up and to the left in FIG. 3). In an exemplary embodiment, forward wall orifice 21 is arranged nonperpendicular and nonparallel to axis of rotation.

In an exemplary embodiment, high-speed pressurized impeller disk 10 comprises aft wall orifice 22 extending from pressurized cavity 16 through aft cavity wall 19. Aft wall orifice 22 extends from forward facing surface 40 to aft facing surface 42. In an exemplary embodiment, aft wall orifice 22 extends radially outward (i.e., in radial direction RD1) in axial direction AD2 (shown as angled down and to the left in FIG. 3). In an exemplary embodiment, aft wall orifice 22 is arranged no perpendicular and nonparallel to axis of rotation.

In an exemplary embodiment, high-speed pressurized impeller disk 10 comprises impeller tip orifice 23 extending from pressurized cavity 16 through tip 15. Impeller tip orifice 23 extends from radially inward facing surface 60 to radially outward facing surface 80 formed by tip 15. In an exemplary embodiment, impeller tip orifice 23 is arranged perpendicular to axis of rotation AX.

Orifice location may be chosen depending on the desired pressure of pressurized cavity 16. For example, since the further the location radially outward along a radial axis (i.e., radial direction RD1) of impeller 10, the higher the velocity of the impeller is, this in turn results in a higher pressure supplied by the orifice. In this example, hub orifice 20 would provide the lowest pressure source, with forward wall orifice 21 and aft wall orifice 22 providing moderate pressure, and tip orifice 23 providing peak pressure.

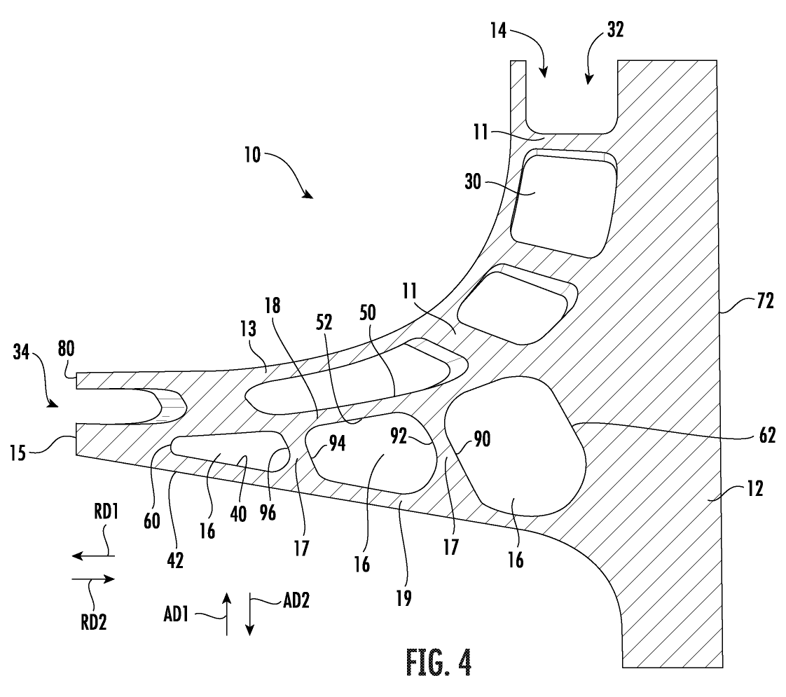

FIG. 4 is a cross-sectional view of high-speed pressurized impeller disk 10 shown in FIG. 1, in which an internal support structure directs the stresses within pressurized cavity 16 to specific regions. The embodied support structure utilizes one or more annular rings 17 to adjoin forward wall 18 and aft wall 19 of pressure cavity 16 at a constant radial position along each face, creating a circumferential box-like structure of the hollow passage. Annular rings 17 extend from forward facing surface 40 to aft facing surface 52. In an exemplary embodiment, at least one annular ring 17 of the one or more annular rings 17 extends radially outward (i.e., in radial direction RD1) in axial direction AD1 (shown as angled up and to the left in FIG. 4). Each annular ring 17 forms a radially inward facing surface 90, 94 and radially outward facing surface 92, 96.

In an exemplary embodiment, high-speed pressurized impeller disk 10 comprises a plurality of annular rings 17, for example, first annular ring 17 and second annular ring 17. First annular ring 17 extends through cavity 16 from aft cavity wall 19 to forward cavity wall 18 and forms radially inward facing surface 90 and radially outward facing surface 92. First annular ring 17 forms a first cavity section arranged radially between radially outward facing surface 62 and radially inward facing surface 90.

Second annular ring 17 extends through cavity 16 from aft cavity wall 19 to forward cavity wall 18 and forms radially inward facing surface 94 and radially outward facing surface 96. Second annular ring 17 forms a second cavity section arranged radially between radially outward facing surface 92 and radially inward facing surface 94, and a third cavity section arranged radially between radially outward facing surface 96 and radially inward facing surface 60. In an exemplary embodiment, the diameter of second annular ring 17 is less than the diameter of first annular ring 17.

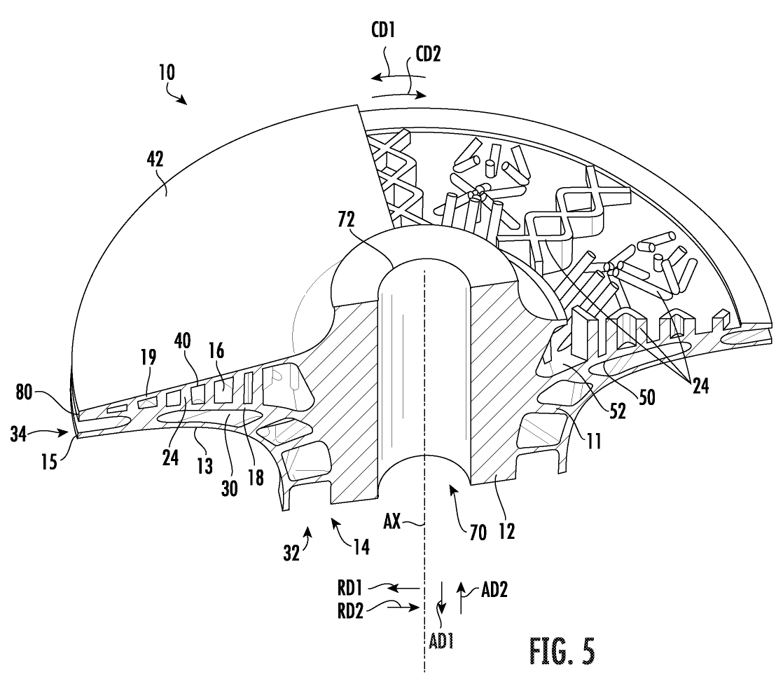

FIG. 5 is an isometric view of high-speed pressurized impeller disk 10 shown in FIG. 1, wherein the internal support structure for stress reduction is not functioning in an axisymmetric fashion and is a unique three-dimensional (3D) truss structure. In an exemplary embodiment, individual beams or baffles 24 adjoin forward wall 18 and aft wall 19 similar to annular rings 17, but with each beam or baffle 24 attaching at specific points on each wall or face circumferentially and not in a constant fashion. Beams or baffles 24 extend across cavity 16 between forward facing surface 40 and aft facing surface 52. This allows for a more pinpoint direction of stresses in the 3D space as opposed to a purely circumferential application. The beams act as a singular load path for transference of force, whereas the baffles act as a high aspect ratio beam following a continuous profile. Beams would be used for areas of very localized stress, such as those seen in the leading edge of a blade. Thus, in an exemplary embodiment, beam 24 is arranged in pressurized cavity 16 at or proximate to the leading edge of blade 11. Baffles would be used across continuous stress regions, such as those seen on the leeward side of the blade relative to rotation. Thus, in an exemplary embodiment, baffle 24 is arranged in pressurized cavity 16 at or proximate to the leeward side or trailing side of blade 11.

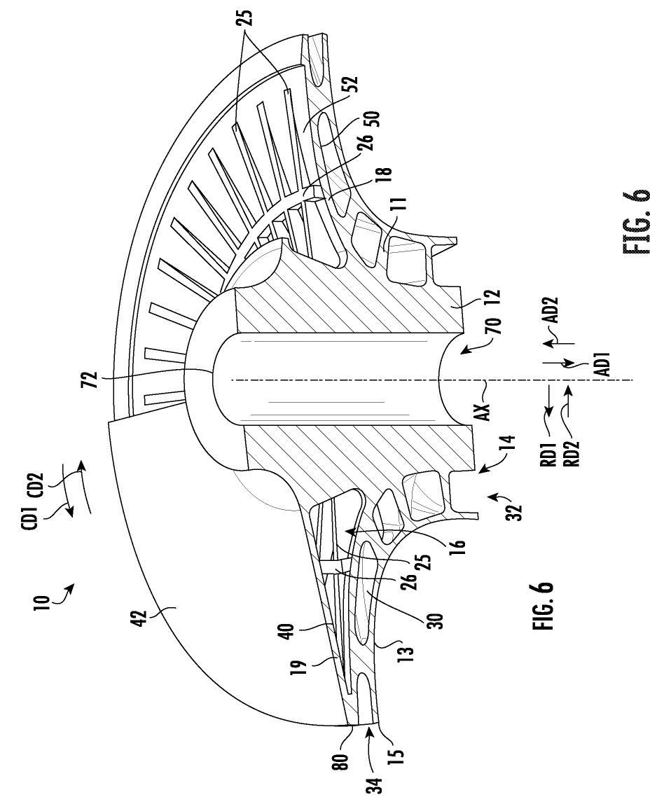

FIG. 6 is an isometric view of high-speed pressurized impeller disk 10 shown in FIG. 1 including one or more internal stiffening ribs. In an exemplary embodiment, the internal stiffening ribs include one or more radially extending stiffening ribs 25. Stiffening ribs 25 extend radially outward from hub 12 in radial direction RD1 and are circumferentially spaced apart along aft facing surface 52. In an exemplary embodiment, ribs 25 extend only partially to tip 15.

In an exemplary embodiment, the internal stiffening ribs include one or more tangential or circumferentially extending stiffening ribs 26. Stiffening rib 26 extends circumferentially (i.e., in circumferential direction CD1, CD2) along aft facing surface 52. In an exemplary embodiment, stiffening rib 26 is an annular rib extending completely around high-speed impeller disk 10. In an exemplary embodiment, stiffening rib 26 is arranged radially between and spaced apart from hub 12 and tip 15.

In an exemplary embodiment, ribs 25, 26 extend from aft facing surface 52 only partially to forward facing surface 40. That is to say, ribs 25, 26 may not be connected to forward facing surface 40, as shown in FIG. 6. In an exemplary embodiment, ribs 25, 26 extend from forward facing surface 40 only partially to aft facing surface 52. That is to say, ribs 25, 26 may not be connected to aft facing surface 52, as shown in FIG. 6. In an exemplary embodiment, ribs 25, 26 extend completely from aft facing surface 52 to forward facing surface 40.

In an exemplary embodiment, ribs 25, 26 may be arranged on both aft facing surface 52 and forward facing surface 40. These ribs, which are oriented radially, tangentially, or a combination of the two are used to stiffen each face or wall, for example forward cavity wall 18 and aft cavity wall 19, independently of one another. Ribs 25, 26 act to control the stress and deflection of an individual face or wall (e.g., forward cavity wall 18 and/or aft cavity wall 19) without shifting the strain energy to the opposite face. However, in specific scenarios as the design necessitates, ribs 25, 26 would adjoin the two faces or walls 18, 19.

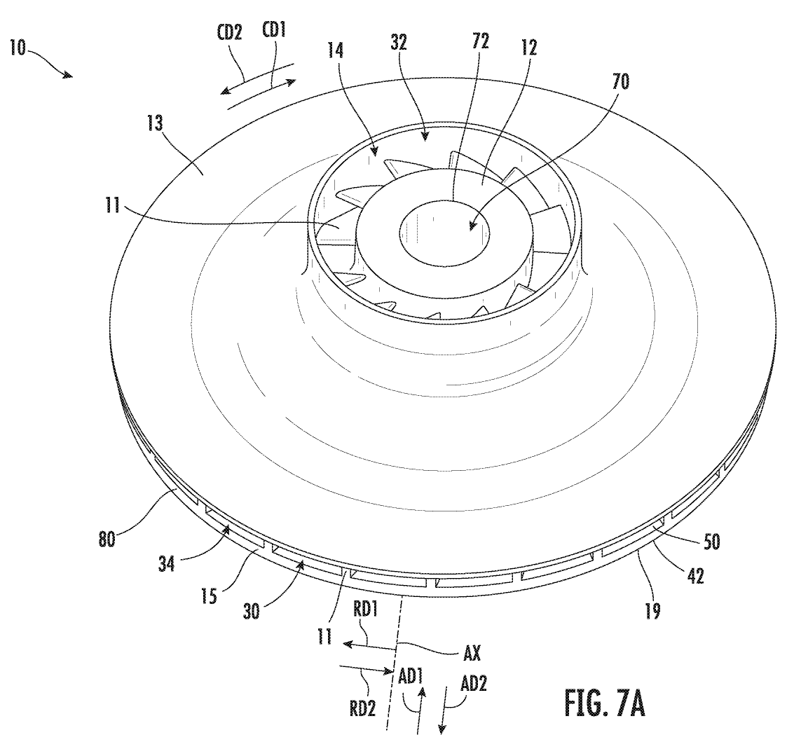

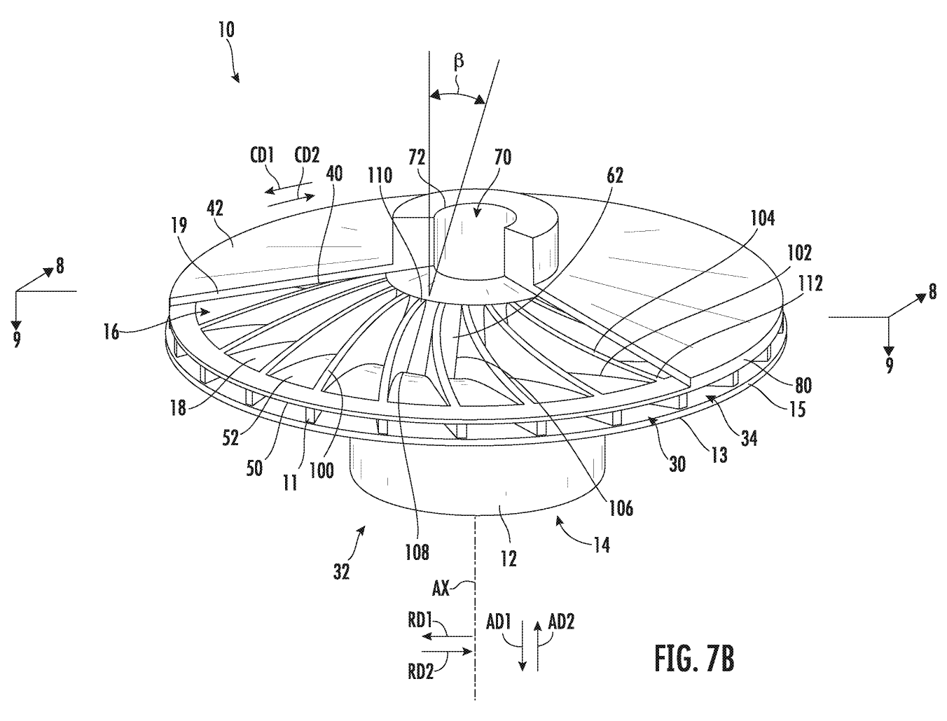

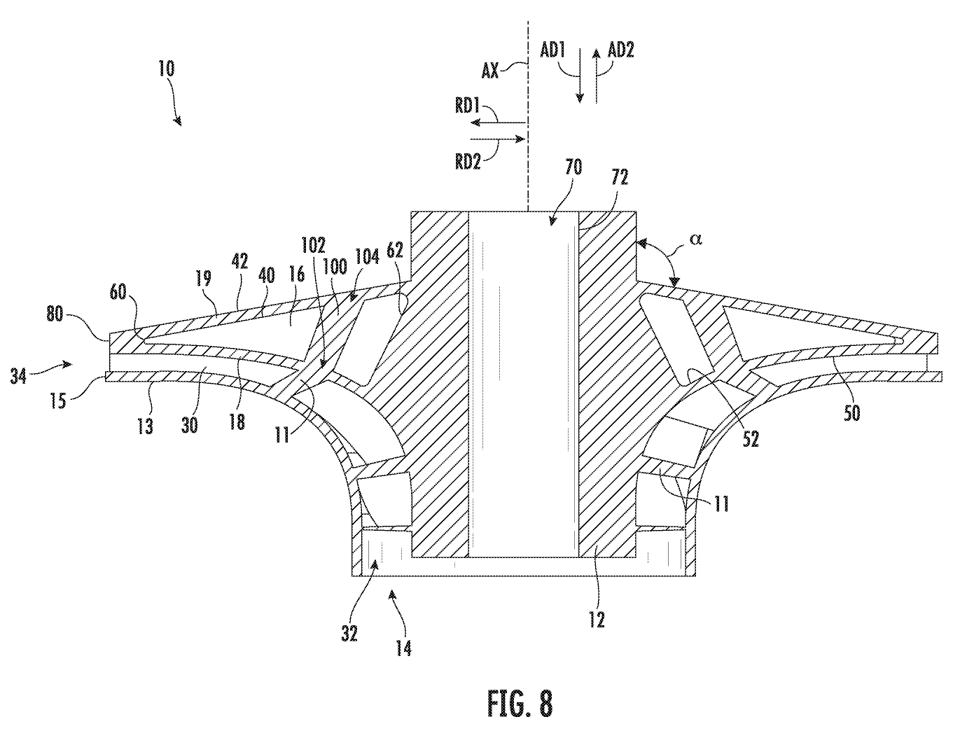

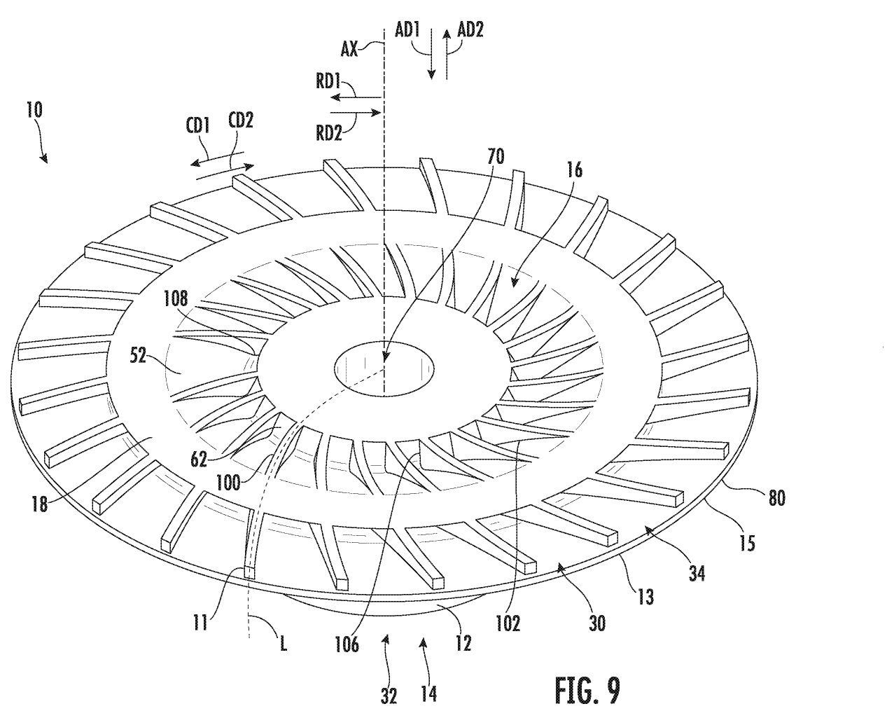

Referring now to FIGS. 7A-9, in an exemplary embodiment high-speed pressurized impeller disk 10. FIG. 7B is a bottom perspective view of high-speed pressurized impeller disk 10. FIG. 8 is a cross-sectional view of high-speed pressurized impeller disk 10 taken generally along line 8-8 in FIG. 7B. FIG. 9 is a cross-sectional view of high-speed pressurized impeller disk 10 taken generally along line 9-9 in FIG. 7B. High-speed pressurized impeller disk 10 generally comprises hub 12, one or more blades 11, forward cavity wall 18, aft cavity wall 19, and one or more stiffening rib, for example, stiffening ribs 100. In an exemplary embodiment, high-speed pressurized impeller disk 10 further comprises shroud 13.

Hub 12 comprises hole or through-hole 70 forming radially inward facing surface 72 and radially outward facing surface 74. In an exemplary embodiment, radially inward facing surface 72 is concentrically arranged about axis AX. High speed pressurized impeller disk 10 is operatively arranged to rotate in circumferential direction CD1, CD2 about axis AX.

Forward cavity wall 18 extends radially outward in radial direction RD1 from hub 12. Forward cavity wall 18 comprises forward facing surface 50 directed generally in axial direction AD1 and aft facing surface 52 directed generally in axial direction AD2. Blades 11 extend along an outer surface of hub 12 and along forward-facing surface 50. In an exemplary embodiment, blades 11 extend radially outward in radial direction RD1 from hub 12 and in circumferential direction CD1, in curvilinear fashion, as will be described in greater detail below. In an exemplary embodiment, shroud 13 is connected to hub 12 and/or forward cavity wall 18 via blades 11. For example, a forward edge of blades 11 is connected to shroud 13 and an aft edge of blades 11 is connected to hub 12 and forward cavity wall 18. Vanes 30 are formed between shroud 13, hub 12, forward cavity wall 18, and adjacent blades 11. Vane 30 comprises end 32 which is arranged at eye 14 of high-speed pressurized impeller disk 10 and end 34 which is arranged at tip 15 and/or radially outward facing surface 80.

Aft cavity wall 19 extends radially outward in radial direction RD1 from hub 12. Aft cavity wall 19 is connected at a distal end thereof to a distal end of forward cavity wall 18, namely, at radially outward facing surface 80 and/or tip 15, thereby forming pressurized impeller cavity 16. Aft cavity wall 19 comprises forward facing surface 40 directed generally in axial direction AD1 and aft facing surface 42 directed generally in axial direction AD2. In an exemplary embodiment, pressurized impeller cavity is fully sealed and allows for the pocket formed thereby to be isobaric, constantly providing the stiffening independent of external forces. The pressure residing in pressurized cavity 16 can be tuned during manufacturing for structural or rotodynamic applications. Put another way, chamber 16 can be pre-pressurized during manufacturing with a pressure greater than ambient air pressure.

Pressurized impeller cavity 16 resides between forward facing surface 40, aft facing surface 52, radially inward facing surface 60, and radially outward facing surface 62. Radially outward facing surface 62 extends from forward facing surface 40 to aft facing surface 52 generally in direction AD1. Radially outward facing surface 62 is arranged proximate hub 12. In an exemplary embodiment, radially outward facing surface 62 is a curvilinear surface. Radially inward facing surface 60 extends from forward facing surface 40 to aft facing surface 52 generally in direction AD1. Radially inward facing surface 60 is arranged proximate to tip 15. In an exemplary embodiment, radially inward facing surface 60 is a curvilinear surface. In an exemplary embodiment, the length of radially inward facing surface 60 is less than the length of radially outward facing surface 62.

Hub 12 may form radially outward facing surface 62. In an exemplary embodiment, radially outward facing surface 62 is a frusto-conical surface increasing in diameter in axial direction AD1. In an exemplary embodiment, radially outward facing surface 74 is a frusto-conical surface increasing in diameter in axial direction AD2 (see FIGS. 5-6). Hub 12 is operatively arranged to connect high-speed pressurized impeller disk 10 to a shaft.

In an exemplary embodiment, and as best shown in FIG. 8, aft cavity wall 19 is arranged at angle α with respect to hub 12, namely, a radially outward facing surface of hub 12. In an exemplary embodiment, angle α is an obtuse angle, for example, in the range of 91°-120°. In an exemplary embodiment, angle α is 100° or about 100°. As previously described, pressurized impeller cavity 16 is arranged aft of blades 11, and acts as the main stress reducing and manipulating feature of the present disclosure.

Blades 11 create the pressure rise in high-speed pressurized impeller disk 10. Blades 11 are spaced apart circumferentially along forward-facing surface 50, for example, in circumferential direction CD1, CD2. From eye 14, blades 11 extend in axial direction AD2, radial direction RD1, and circumferential direction CD1. In an exemplary embodiment, eye 14 acts as the impeller inlet, and flow exits high-speed pressurized impeller disk 10 at tip 15. In an exemplary embodiment, for example in a radial turbine, tip 15 acts as the impeller inlet and flow exits high-speed pressurized impeller disk 10 at eye 14. Vanes 30 are formed circumferentially between blades 11 and include vane suction or inlet end 32 and vane discharge end 34. It should be appreciated that when high-speed pressurized impeller disk 10 is utilized as a radial inflow turbine the fluid flow in vanes 30 is reversed such that vanes 30 comprise vane suction or inlet end 34 and vane discharge end 32.

High-speed pressurized impeller disk 10 further comprises an internal support structure operatively arranged to direct the stresses within pressurized cavity 16 to specific regions. For example, high-speed pressurized impeller disk 10 comprises one or more internal stiffening ribs, for example, stiffening ribs 100. Stiffening rib 100 extend radially outward in radial direction RD1 from hub 12 and are circumferentially spaced apart along aft facing surface 52. Additionally, and as best shown in FIGS. 7B and 9, stiffening rib 100 also extends in circumferential direction CD1 with respect to hub 12. In an exemplary embodiment, stiffening rib 100 is a curvilinear plate extending on aft facing surface 52 generally along line L.

Stiffening rib 100 comprises forward edge 102 connected to aft facing surface 52 of forward cavity wall 18, aft edge 104 connected to forward facing surface 40 of aft cavity wall 19, proximal edge 106, and distal tip 112. In an exemplary embodiment, proximal edge 106 is connected to radially outward facing surface 62 and/or hub 12. Proximal edge 106 generally extends along radially outward facing surface 62 from aft cavity wall 19 to forward cavity wall 18 in axial direction AD1. Proximal edge 106 comprises proximal edge point 108 connected to radially outward facing surface 62 proximate to and/or at forward cavity wall 18 and proximal edge point 110 connected to radially outward facing surface 62 proximate to and/or at aft cavity wall 19.

As best shown in FIG. 7B, proximal edge point 108 is spaced apart from proximal edge point 110 in circumferential direction CD2 with respect to radially outward facing surface 62. For example, proximal edge 106 is twisted or skewed such that it is non-parallel with axis AX on radially outward facing surface 62. In an exemplary embodiment, stiffening rib 100 is arranged non-radial or substantially non-radial at hub 12. By non-radial it is meant that stiffening rib 100, namely proximal edge 106 is not perpendicular (e.g., is arranged diagonal) to the direction of travel or rotation. In an exemplary embodiment, proximal edge 106 is arranged at angle β with respect to axis AX. In an exemplary embodiment, angle β is an acute angle, for example, 5°-20°. In an exemplary embodiment, angle β is 15° or about 15°. In an exemplary embodiment, stiffening rib 100 is arranged radial or substantially radial at or proximate to distal tip 112. by radial it is meant that stiffening rib 100 is arranged perpendicular to the direction of travel or rotation at or proximate distal tip 112.

Distal tip 112 is arranged proximate to tip 15 and/or radially outward facing surface 80. In an exemplary embodiment, distal tip 112 is spaced apart from tip and/or radially outward facing surface 80 in radial direction RD2 (i.e., stiffening rib 100 extends only partially to tip 15 and/or radially outward facing surface 80). In an exemplary embodiment, distal tip 112 extends completely to tip 15 and/or radially outward facing surface 80. In an exemplary embodiment, and as shown, stiffening ribs 100 extend completely from aft cavity wall 19 to forward cavity wall 18. In an exemplary embodiment, stiffening ribs 100 extend only partially from forward cavity wall 18 to aft cavity wall 19. In an exemplary embodiment, the axial length of proximal edge 106 is greater than the axial length of distal tip. For example, stiffening rib 100 may decrease in length in axial direction AD1, AD2 in a radially outward direction, namely, radial direction RD1.

In an exemplary embodiment, and as best shown in FIGS. 7B and 9, stiffening ribs 100 track to the profile contour of blades 11, for at least a portion of blades 11. For example, at least one stiffening rib 100 extends along aft facing surface 52 in a path that is aligned with the path of extension of corresponding blade 11 along forward-facing surface 50. In an exemplary embodiment, each stiffening rib 100 is aligned with a corresponding blade 11 along forward cavity wall 18, for example, along line L. By aligned along forward cavity wall 18, it is meant that an axis drawn through any point of forward edge 102 of stiffening rib 100 in axial direction AD1 will also extend through a portion of corresponding blade 11 abutting forward facing surface 50.

In an exemplary embodiment, both stiffening rib 100 and corresponding blade 11 curve in a circumferential direction, for example circumferential direction CD1, as they extend from hub 12 toward tip 15 and/or radially outward facing surface 80. In an exemplary embodiment, stiffening rib 100 is an extension (i.e., blade surface tangent or adjacent) of corresponding blade 11. Thus, stiffening rib 100 can be thought of as an extension of blade 11 wherein forward cavity wall 18 extends radially therebetween (i.e., with blade 11 extending generally in axial direction AD1 and stiffening rib 100 extending generally in axial direction AD2 with respect to forward cavity wall 18).

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

### REFERENCE NUMERALS

10 High-speed pressurized impeller disk

11 Blade

12 Hub

13 Shroud

14 Eye

15 Tip

16 Pressurized internal cavity

17 Annular ring or support structure

18 Forward cavity wall

19 Aft cavity wall

20 Hub orifice

21 Forward orifice

22 Aft orifice

23 Tip orifice

24 Beams or baffles

25 Stiffening rib

26 Stiffening rib

30 Vane

32 End

34 End

40 Forward facing surface

42 Aft facing surface

50 Forward facing surface

52 Aft facing surface

60 Radially inward facing surface

62 Radially outward facing surface

70 Hole or through-hole

72 Radially inward facing surface

80 Radially outward facing surface

90 Radially inward facing surface

92 Radially inward facing surface

94 Radially inward facing surface

96 Radially outward facing surface

100 Stiffening rib

102 Forward edge

104 Aft edge

106 Proximal edge

108 Proximal edge point

110 Proximal edge point

112 Distal tip

AD1 Axial direction

AD2 Axial direction

AX Axis

CD1 Circumferential direction

CD2 Circumferential direction

L Line

RD1 Radial direction

RD2 Radial direction

α Angle

β Angle

What is claimed is:

1. A pressurized impeller, comprising:
a hub;
a tip;
a forward cavity wall including a first forward surface and a first aft surface;
an aft cavity wall including a second forward surface and a second aft surface;
an axial opening;
a radial opening arranged proximate the tip;
one or more blades arranged on the first forward surface;
a plurality of fluid flow paths formed between the axial opening, the radial opening, and the one or more blades;
an internal pressurized cavity formed between the forward cavity wall and the aft cavity wall; and
a support structure arranged in the internal pressurized cavity.

2. The pressurized impeller as recited in claim 1, wherein the support structure comprises a stiffening rib arranged on the first aft surface.

3. The pressurized impeller as recited in claim 2, wherein the stiffening rib is at least partially aligned with a blade of the one or more blades along the forward cavity wall.

4. The pressurized impeller as recited in claim 2, wherein:
the stiffening rib comprises a forward edge fixedly secured to the first aft facing surface; and
the forward edge is always aligned with a blade of the one or more blades along the forward cavity wall.

5. The pressurized impeller as recited in claim 2, wherein the stiffening rib is a curvilinear plate extending from the hub at least partially to the tip.

6. The pressurized impeller as recited in claim 5, wherein an axial length of the stiffening rib decreases in a radially outward direction.

7. The pressurized impeller as recited in claim 2, wherein:
the stiffening rib comprises a proximal edge connected to the hub;
the pressurized impeller further comprises an axis of rotation; and
the proximal edge is arranged at an acute angle with respect to the axis of rotation.

8. The pressurized impeller as recited in claim 1, wherein the support structure comprises at least one stiffening rib arranged on at least one of the first aft surface and the second forward surface.

9. The pressurized impeller as recited in claim 1, wherein the at least one stiffening rib extends in:
a radially outward direction relative to the hub; or
a circumferential direction around the hub.

10. The pressurized impeller as recited in claim 1, wherein the support structure comprises one or more annular rings extending circumferentially around the hub.

11. The pressurized impeller as recited in claim 10, wherein each ring of the one or more annular rings:
is arranged radially between and spaced apart from the tip and the hub; and
extends from the aft wall to the forward wall.

12. The pressurized impeller as recited in claim 10, wherein at least one ring of the annular ring is arranged nonparallel to the axis of rotation.

13. The pressurized impeller as recited in claim 1, further comprises at least one stiffening rib arranged on at least one of the first aft surface and the second forward surface.

14. The pressurized impeller as recited in claim 13, wherein the at least one stiffening rib extends in a radially outward direction relative to the hub.

15. The pressurized impeller as recited in claim 13, wherein the at least one stiffening rib extends in a circumferential direction around the hub.

16. The pressurized impeller as recited in claim 1, wherein the support structure comprises a beam arranged on the first aft surface proximate a leading edge of a blade of the pressurized impeller.

17. A pressurized impeller, comprising:
a hub;
a tip;
a forward cavity wall including a first forward surface and a first aft surface;
an aft cavity wall including a second forward surface and a second aft surface;
an axial opening;
a radial opening arranged proximate the tip;
one or more blades arranged on the forward cavity wall;
a plurality of fluid flow paths formed between the axial opening, the radial opening, and the one or more blades;
an internal pressurized cavity formed between the forward cavity wall and the aft cavity wall; and
one or more stiffening ribs arranged on the forward cavity wall;
wherein at least one blade of the one or more blades and at least one stiffening rib of the one or more stiffening ribs are aligned along the forward cavity wall in a path extending from the hub at least partially to the tip.

18. The pressurized impeller as recited in claim 17, wherein the path is curvilinear.

19. The pressurized impeller as recited in claim 17, wherein:
the one or more blades are arranged on the first forward surface; and
the one or more stiffening ribs are arranged on the first aft surface.

20. The pressurized impeller as recited in claim 17, wherein at least one stiffening rib of the one or more stiffening ribs is a curvilinear plate decreasing in axial length in a radially outward direction with respect to the hub.
